(19) United States
(12) Patent Application Publication
(10) Pub. No.: US 2025/0332714 A1
(43) Pub. Date: Oct. 30, 2025

(54) DRILLING AND/OR DIE-CUTTING UNIT

(71) Applicant: FK GROUP S.P.A., Dalmine (Bergamo) (IT)

(72) Inventor: Flavio CATTINI, Dalmine (Bergamo) (IT)

(21) Appl. No.: 18/875,204

(22) PCT Filed: May 19, 2023
(86) PCT No.: PCT/IB2023/055183

§ 371 Date: Dec. 16, 2024

(30) Foreign Application Priority Data
Jun. 21, 2022 (IT) 102022000013102

(51) Int. Cl. B25J 9/12; B25J 11/00

(52) U.S. Cl. CPC B25J 9/12; B25J 11/0055

(57) ABSTRACT

A drilling and/or die-cutting unit has a robotic arm on whose wrist an electromechanical member suitable for operatively supporting a drill or die-cutting bit is mounted. The electromechanical member has a toroidal-shaped motor group extending about a motor rotation axis and provided with couplings for coupling to the drill or die-cutting bit, and suitable for supporting the drill or die-cutting bit coaxially to the motor rotation axis. The drilling and/or die-cutting unit is for flat pieces made of deformable materials, optionally the flat pieces made of deformable materials being textiles.

The present invention relates to a unit for drilling and/or die-cutting, in particular for flat pieces in deformable materials, e.g., textiles.

The drilling unit here proposed may, for example, be used in cutting machines for textiles, or other flat, deformable: materials, suitable for performing blade cutting of shapes or along lines by importing a cutting path (called “nesting” in jargon) via software. In addition to cutting, in fact, these machines may also be required to make holes in the material, even of different sizes.

Therefore, in some known embodiments, an automatic cutting machine of the type mentioned above comprises a cutting table which supports a cutting mat and which extends between an area for loading the flat piece onto the cutting mat and an area for unloading the flat piece from the cutting mat. The cutting mat also acts as a conveyor belt and is therefore translatable on the cutting table to transport the flat piece from the loading area to the unloading area.

The machine is equipped with a cutting unit that has a blade or knife and is movable above the cutting mat to perform flat piece cutting in closed shapes or other figures, such as simple cutting along lines, according to a predetermined cutting path. For example, the cutting unit is mounted on a slidable beam along the travel direction of the cutting mat. The cutting unit is also slidable along the beam and therefore orthogonally to the travel direction of the cutting mat. In this way, the cutting blade may reach any position in the plane defined by the cutting mat.

In the automotive, aerospace, apparel, and composite materials sectors, it is common to put in very long nestings (e.g., 10-12 m), wherein there are also numerous holes, with diameters that may vary from 1 to 30 mm, for example. The holes are needed to fix, for example by means of clips, cut materials to the supporting structures of a finished product.

For example, in an automobile the soft lining parts of an engine hood or luggage compartment are attached to the metal structure with buttons and clips that engage these holes; some deformable components of headrests also need to have holes as circular references for matching them to the upholstery parts, paddings, etc.

Currently, in order to drill these holes during the work cycle of an automatic cutting machine, it is necessary to install on board the cutting head beam one or more devices, such as drills and/or dies, with diameters which are consistent with the size of the holes.

It is therefore clear that such drilling devices, being associated with the cutting head and thus being subject to sizing and positioning constraints, may not be designed in a way that optimizes their performance and facilitates the tool change operation to make holes of different sizes.

The object of the present invention is to propose a drilling unit, particularly, but not exclusively, for a flat-piece cutting machine, which may offer high performance and reduce the time for the tool change operation.

This object is achieved with a drilling unit according to claim 1. The dependent claims describe preferred or advantageous embodiments of the invention.

The features and the advantages of the drilling unit according to the invention shall be made readily apparent from the following description of preferred embodiments thereof, provided purely by way of a non-limiting example, with reference to the accompanying figures, wherein:

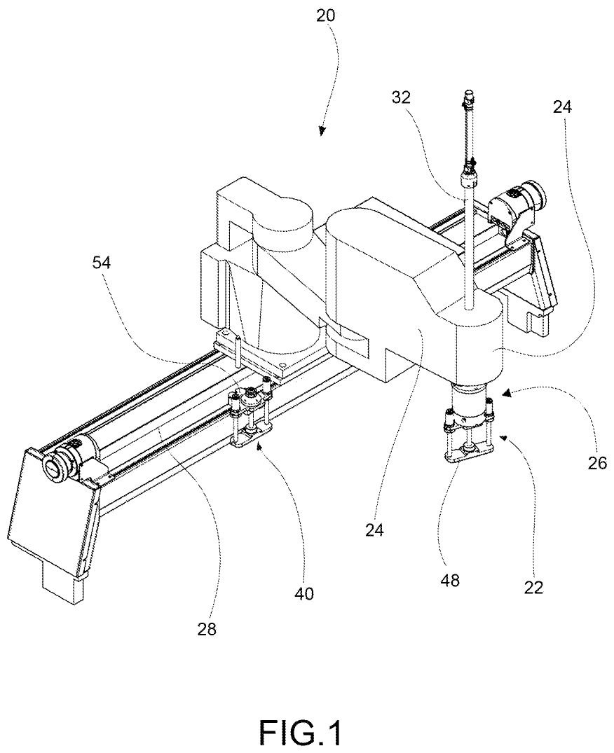

FIG. 1 is a perspective view of a drilling and/or die-cutting unit according to the invention;

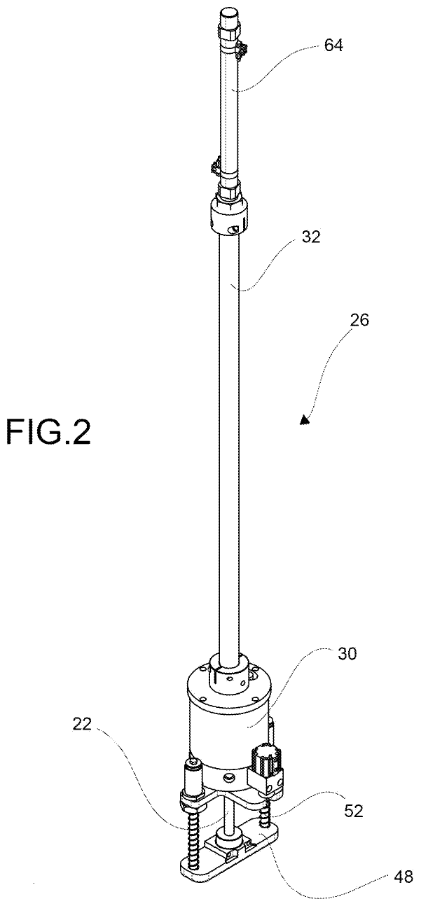

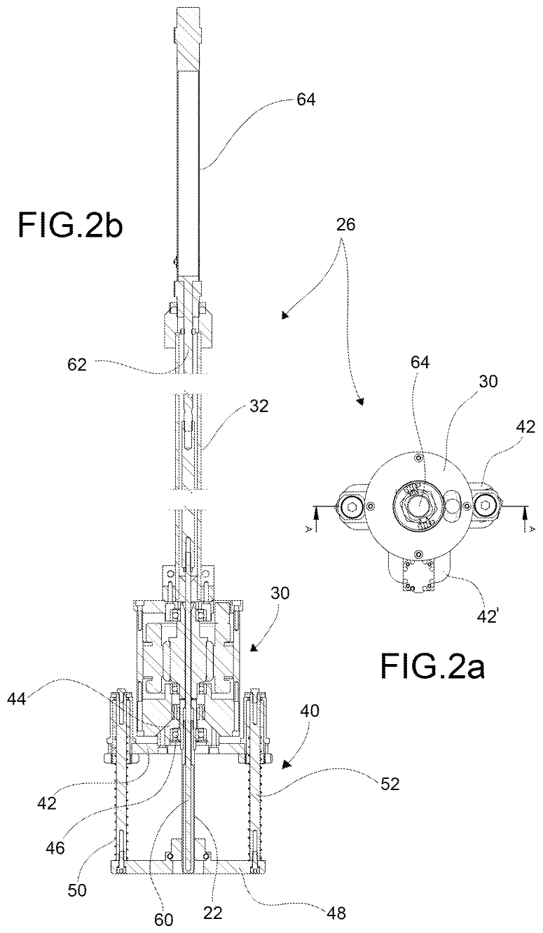

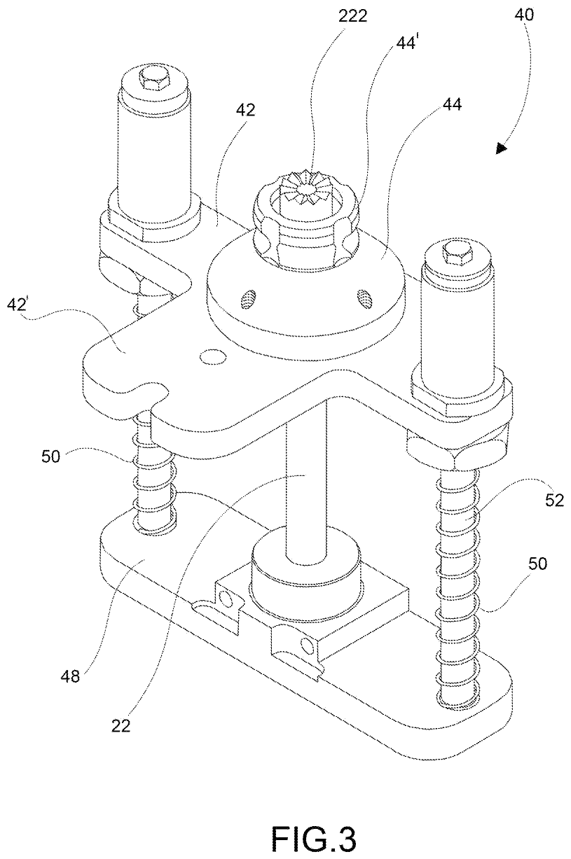

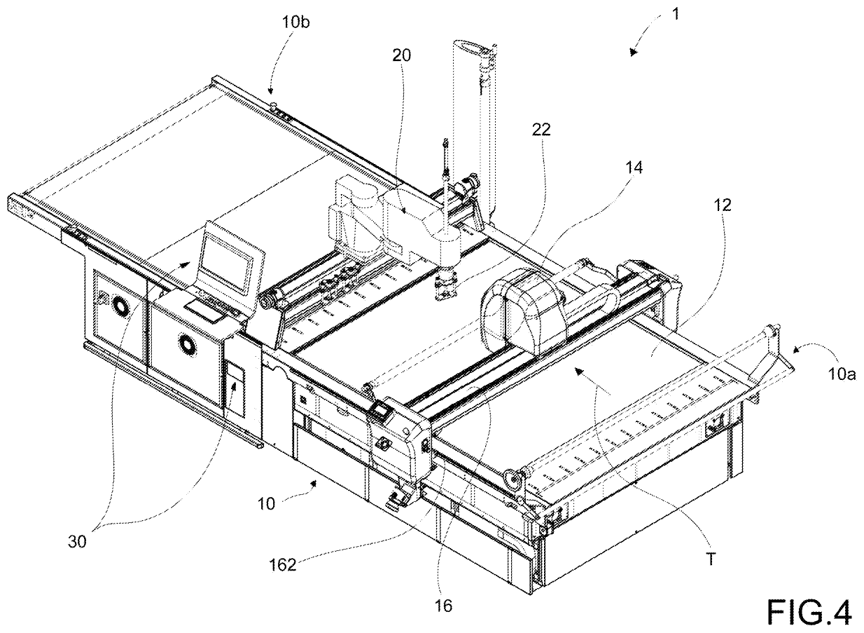

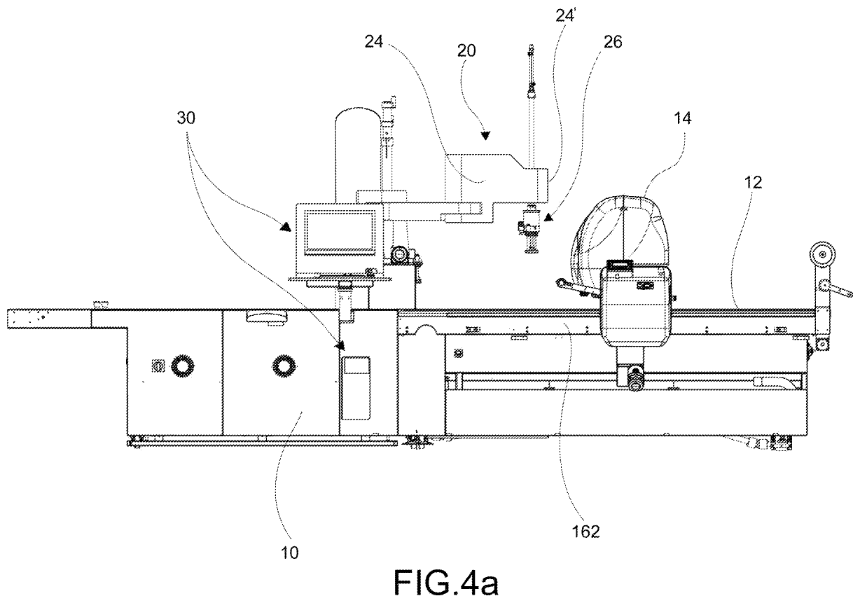

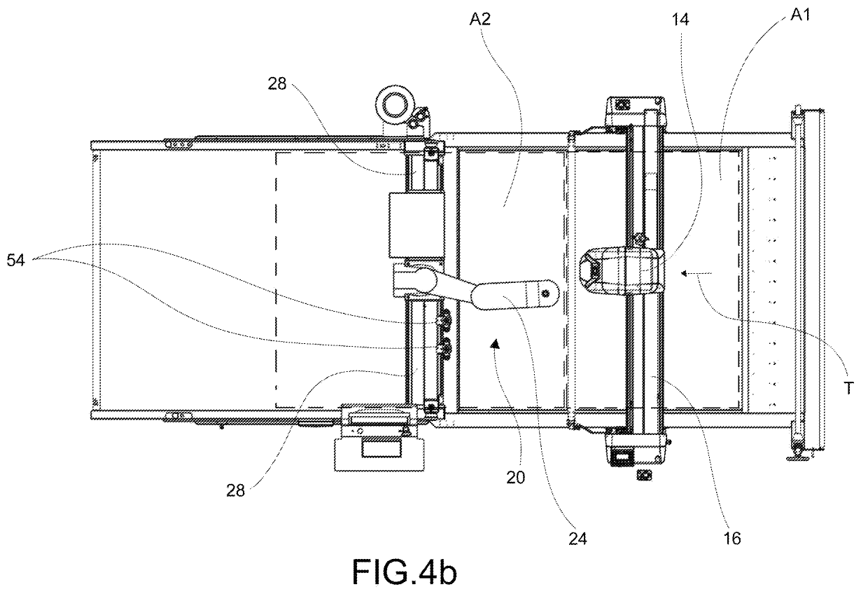

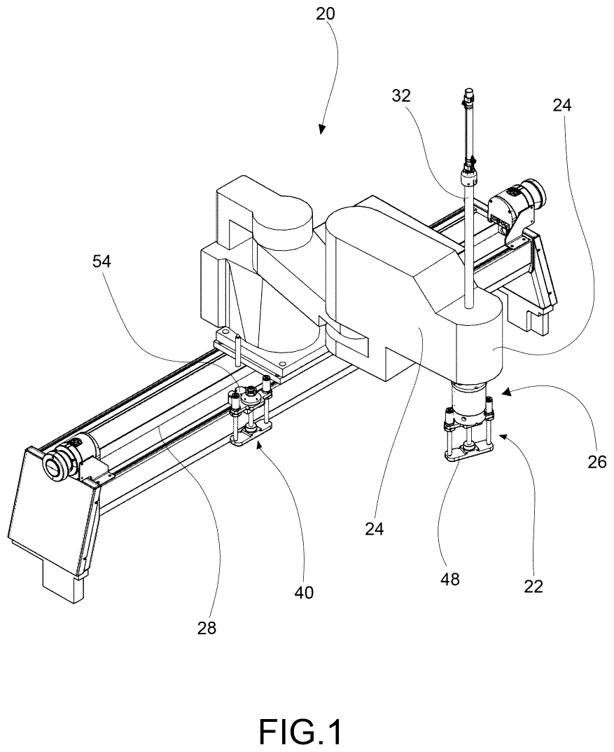

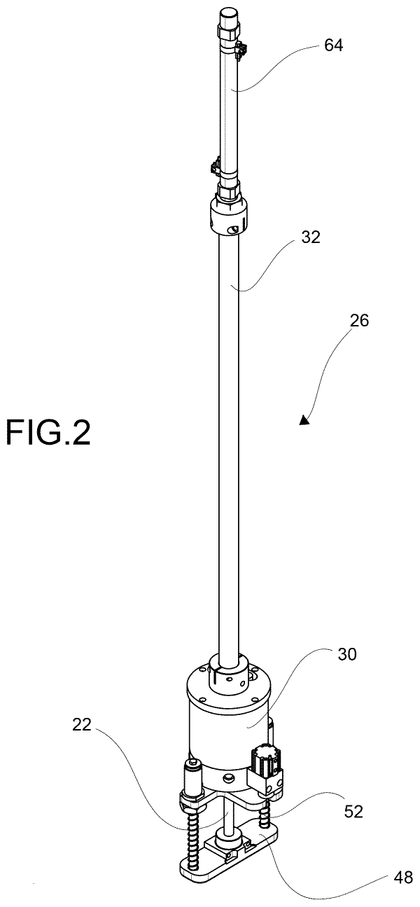

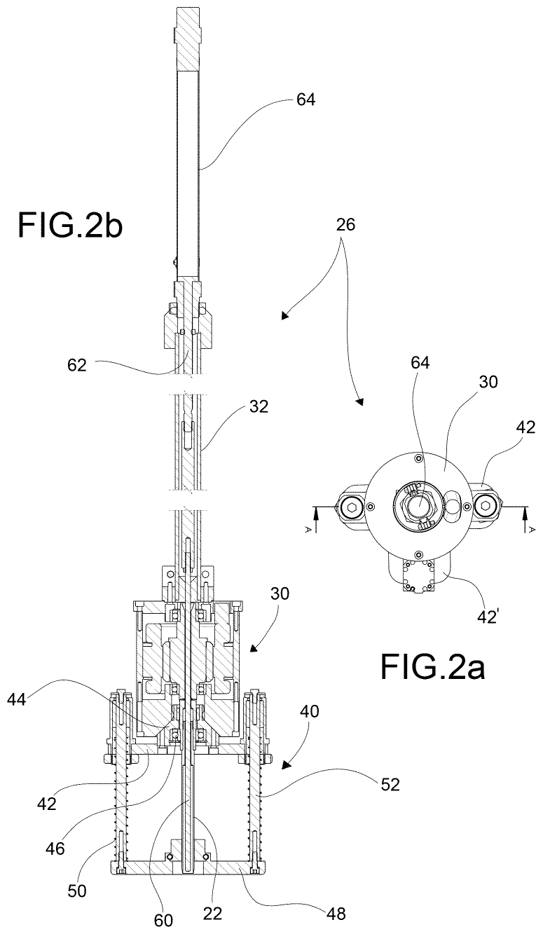

FIG. 2 is a perspective view of an electromechanical member of the drilling and/or die-cutting unit in FIG. 1, on which a die-cutting tool is mounted;

FIG. 2a is a plan view from above of the electromechanical member in FIG. 2;

FIG. 2b is an axial section of the electromechanical member and the die-cutting tool thereof;

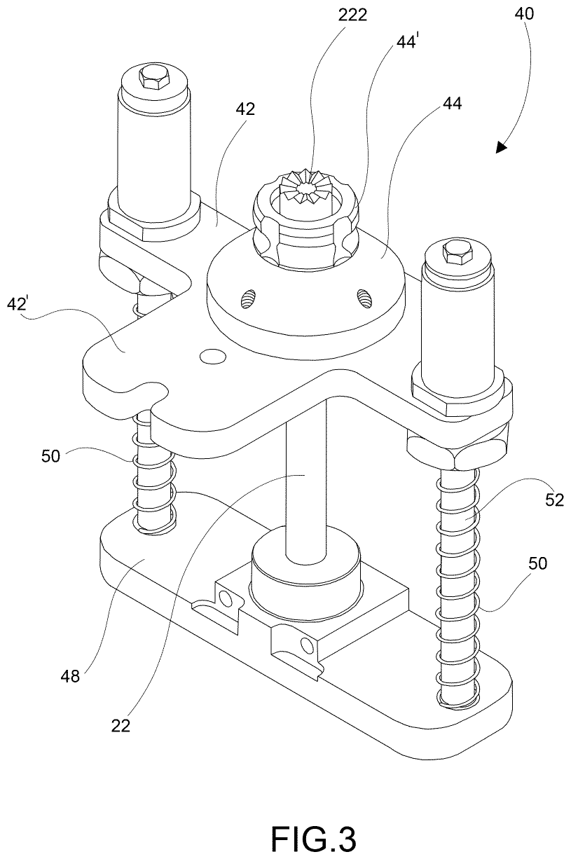

FIG. 3 is a perspective view of the die-cutting tool alone, in one embodiment;

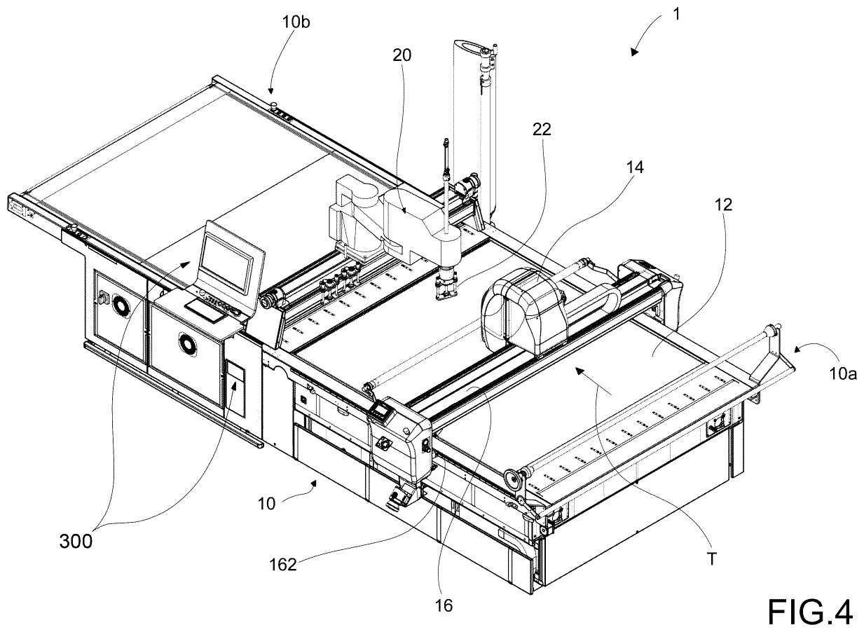

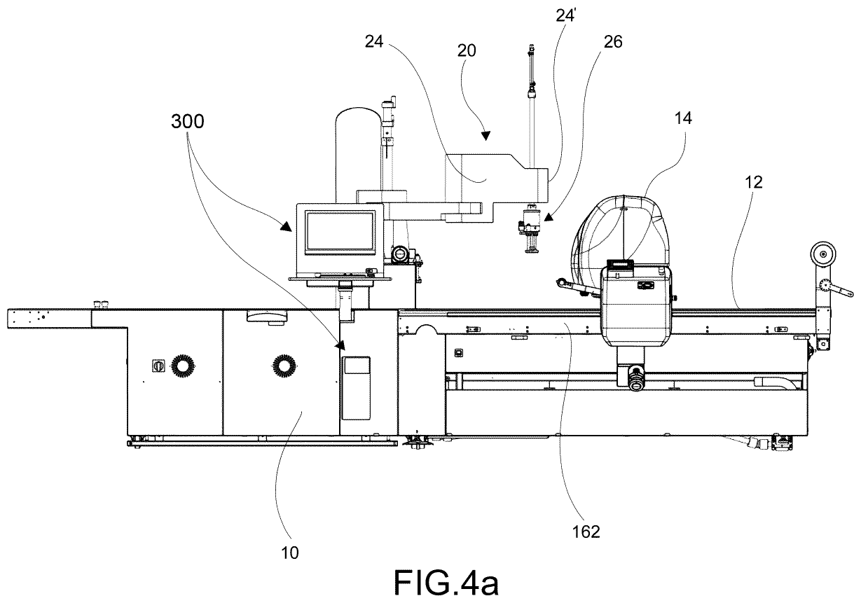

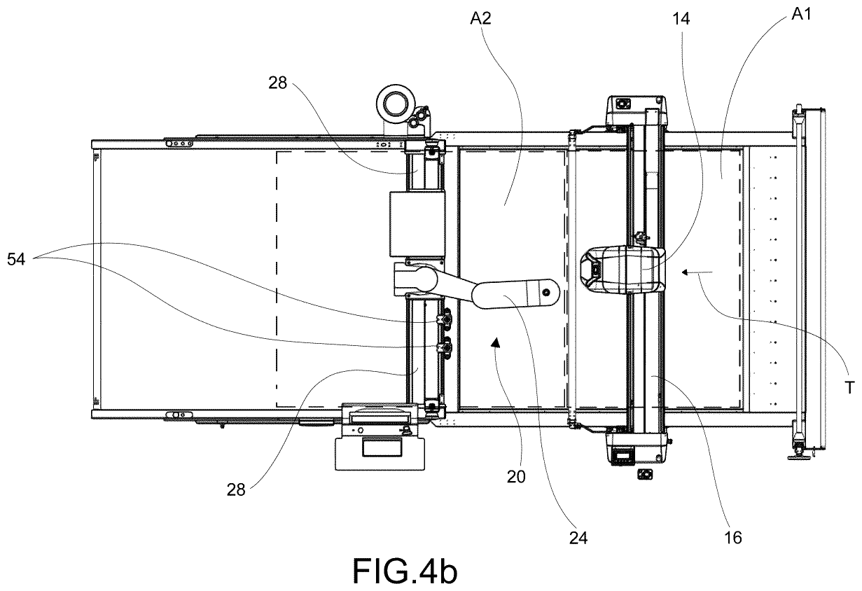

FIG. 4 is a perspective view of a cutting machine that comprises the drilling and/or die-cutting unit according to the invention, in one embodiment;

FIG. 4a is an elevation view of the machine in FIG. 4; and

FIG. 4b is a plan view from the top of the machine in FIG. 4, wherein two different work areas are denoted with dashed lines.

In said drawings, 20 denotes as a whole a drilling and/or die-cutting unit for drilling holes in a flat piece made of a deformable material.

The drilling and/or die-cutting unit 20 is particularly, but not exclusively, suitable for being used on a cutting machine 1 for the automatic cutting of flat pieces of deformable material, e.g., textiles.

The cutting machine 1 is able to process a single flat piece (single-ply machine in the case of textiles) or a plurality of superimposed flat pieces (multiple-ply stack in the case of textiles). In the latter case, the processing units described below are able to simultaneously process all the superimposed flat pieces (the stack) as if they were a single piece. In the remainder of the description, for ease of explanation, the term “flat piece” will therefore be used both to refer to a single flat element and to refer to several flat elements superimposed to form a stack.

In the following description, the drilling and/or die-cutting unit 20 is used on this cutting machine 1, but this use should be considered only as an example of the possible applications of the drilling and/or die-cutting unit according to the invention.

The machine 1 comprises a cutting table 10 that supports a cutting mat 12. The cutting table 10 extends between a loading area 10a of the flat piece onto the cutting mat 12 and an unloading area 10b of the flat piece from the cutting mat 12.

The cutting mat 12 is made, for example, as a needle mat or of a felt-like material that specifically allows a cutting blade to pass through. Moreover, the cutting mat 12 may be equipped with piece clamping means, such as suction means, suitable for clamping the flat piece on the surface of the cutting mat 12.

In one embodiment, the cutting mat 12 is translatable on the cutting table 10 to transport the flat piece from the loading area 10a to the unloading area 10b (see arrow T in FIGS. 1 and 1b). For example, the cutting mat 12 is movable as a conveyor belt (or several adjacent conveyor belts) and is therefore wrapped around two (or more) drive rollers positioned at least at the loading area 10a and the unloading area 10b.

The machine 1 is equipped with a cutting unit 14. This cutting unit 14 is equipped with a blade, or knife. The blade or knife may be fixed, such as in the case of single-ply cutting, or suitable for being moved vertically to perform flat piece cutting, such as in the case of multi-ply textiles.

The cutting unit 14 may be of the type conventionally used for these automatic textile cutting machines, and therefore its structure and operation are known to the person skilled in the art and require no further description. An example of a cutting head is described in WO2014064568A2, in the name of the same Applicant.

The cutting unit 14 is movable over a first area A1 of the cutting mat 12 (see FIG. 1b) to perform flat piece cutting in accordance with a predetermined cutting path.

The coordinates of the predetermined cutting path therefore refer to this first area A1 of the cutting mat. For example, the coordinates of the cutting path are calculated with respect to a reference point of the first area A1, for example coinciding with a vertex of that first area A1.

In one embodiment, the first area A1 corresponds to the whole area of the cutting machine engaged by the cutting mat 12.

In one embodiment, the cutting unit 14 is mounted on a beam 16 that extends over the cutting table 10 perpendicular to the travel direction (T) of the cutting mat 12 and is slidable along side guides 162 of the cutting table 10, which side guides extend parallel to the travel direction of the cutting mat 12.

The cutting unit 14 is also slidable along the beam 16. Therefore, the blade may reach any position in the plane defined by the first area A1.

The machine 1 is equipped with at least one drilling and/or die-cutting unit 20 suitable for drilling holes in the flat piece.

In the context of this description, the term “drilling” refers to making small-diameter holes that require a cold or hot bit similar to a drill bit; the term “die-cutting” refers to making larger-diameter holes that require a rotary die and then an ejector to eject the material that remains inserted in the die following the die-cutting.

In a general embodiment, the drilling and/or die-cutting unit 20 is movable over a second area A2 of the cutting mat 12. The drilling and/or die-cutting unit 20 is suitable for drilling holes in the flat piece according to a predetermined drilling and/or die-cutting path.

In one embodiment, the second area A2 coincides with the first area A1 and may therefore correspond to the area of the cutting machine engaged by the cutting mat 12.

In a variant embodiment, the second area A2 is an area within the area A1.

In a variant embodiment, the second area A2 is at least partially distinct from the first area A1.

In an embodiment shown in FIG. 1b, the first area A1 and the second area A2 are two distinct areas adjacent to each other.

The coordinates of the predetermined drilling and/or die-cutting path may therefore refer to the second area A2 of the cutting mat 12.

It should be noted that if the cutting mat 12 is a movable mat for transporting the flat piece, the first and second areas A1, A2 of the cutting mat 12 do not necessarily mean physical portions of the cutting mat 12, but rather portions of the surface of the cutting table 10 engaged by the side of the cutting mat facing outward, that is, upward. If, on the other hand, the cutting machine 1 operates with a fixed cutting mat 12 and the flat piece is advanced along the cutting mat 12 by other handling means, then these first and second areas A1, A2 may be considered also portions of the cutting mat 12.

In one embodiment, the drilling and/or die-cutting unit 20 is movable above the second area A2 independently of the movement of the cutting unit 14 on the first area A1.

However, the drilling and/or die-cutting unit 20 is a separate unit from the cutting unit 14, that is, it is placed on a support structure distinct from the one supporting the cutting unit 14.

The cutting unit 14 and the drilling and/or die-cutting unit 20 are controlled by an electronic control unit 300.

The electronic control unit 300 is programmed to actuate the drilling and/or die-cutting unit 20 at the same time as the cutting unit 14 in at least one stage of cutting the flat piece.

In the case of at least partially distinct first and second areas A1, A2, the electronic control unit 300 is programmed to actuate the drilling and/or die-cutting unit 20 when the flat piece enters at least partially in the second area A2 of the cutting mat 12.

In the case of first and second areas A1, A2 coinciding with each other, the electronic control unit 300 is programmed to manage the operations of the cutting unit 14 and the drilling and/or die-cutting unit 20 in such a way that the two units may operate simultaneously but without interfering with each other.

Therefore, the two processes may take place simultaneously (at least during one stage of the machine's work cycle), that is, in parallel, rather than alternately with each other as in current machines. The simultaneous operation of the cutting unit and the drilling and/or die-cutting unit within the work cycle of the material results in a reduction in downtime and less material crossing time of the material to be cut and drilled (or to be subjected to other processing), with obvious advantages in terms of work cycle productivity.

Further, the cutting unit, unloaded, for example, of the components needed for drilling or other processing, is lighter and therefore more efficient.

In some embodiments, the machine 1 is provided with position sensors suitable for providing the electronic control unit 300 with information on the position of the flat piece with respect to the first and second areas A1, A2 of the cutting mat 12. In this way, for example, when a portion of the flat piece subjected to drilling and/or die-cutting enters in the second area A2, the electronic control unit 300 actuates the drilling and/or die-cutting unit 20.

In one embodiment, the machine 1 comprises a mat actuator—not shown—controllable by the electronic control unit 300 for the automatic translation of the cutting mat 12 on the cutting table 10.

In one embodiment, the electronic control unit 300 is programmed to drive the mat actuator in such a way that the translation of the cutting mat 12 occurs intermittently, that is, in steps.

In a variant embodiment, the electronic control unit 300 is programmed to drive the mat actuator so that the translation of the cutting mat 12 occurs continuously. In this case, the cutting unit 14 and the drilling and/or die-cutting unit 20 are controllable so that cutting and drilling and/or die-cutting are performed while the cutting mat 12 is moving.

In one embodiment, the cutting path is described in a CAD file that also includes the drilling and/or die-cutting path. The electronic control unit 300 receives this CAD file and, using the coordinates of the cutting path and the drilling and/or die-cutting path, provides command instructions for the actuation of the cutting unit 14 and the drilling and/or die-cutting unit 20.

In one embodiment, the second area A2 of the cutting mat is defined downstream or upstream of the first area A1 of the cutting mat in the travel direction (T) of the flat piece.

More precisely, in the case wherein the portion of the cutting table engaged by the cutting mat 12 has a rectangular area, in an embodiment illustrated in FIG. 1b the first and second areas are two rectangular portions that are essentially consecutive and adjacent. In other words, the first and second areas are two partitions of this rectangular area of the cutting mat 12.

The drilling and die-cutting unit 20, being released from the cutting unit 14, may be designed to make holes even of different diameters on the flat piece very precisely and quickly.

In one embodiment, the drilling and/or die-cutting unit 20 comprises a robotic arm 24.

In the case of application on the cutting machine 1, the robotic arm 24 may be positioned downstream or upstream of the cutting unit 14 along the travel direction (T) of the flat piece on the cutting table.

An electromechanical member 26 suitable for operatively supporting a drill or die-cutting bit 22 is mounted on the wrist 24′ of the robotic arm 24.

For example, the robotic arm 24 is supported by an arm beam 28 fixed to the cutting table 10 and extending between opposite sides thereof, perpendicular to the travel direction (T) of the flat piece.

In an alternative embodiment, the robotic arm 24 may also be attached to a structure above the cutting machine 1.

In one embodiment, the robotic arm 24 is suitable for completing movements only in a plane parallel to the flat piece to be drilled, such as a horizontal plane, and the electromechanical member 26 is suitable for moving the drill or die-cutting bit 22 in the direction orthogonal to the flat piece to be drilled, such as in a vertical direction.

In one embodiment, the electromechanical member 26 comprises a toroidal-shaped motor group 30 (also known as a “torque” motor), that is, which extends coaxially about a motor rotation axis. The motor group 30 is provided with coupling means to the drill or die-cutting bit 22.

In one embodiment, such coupling means are suitable for supporting the drill or die-cutting bit 22 coaxially to the motor rotation axis. In other words, it is possible to mount the motor group 30 on the wrist 24′ of the robot arm 24 in such a way that the motor rotation axis is oriented vertically, thus coaxially with the direction of insertion of the drill or die-cutting bit 22 into the flat piece.

In one embodiment, the motor group 30 is attached to the lower end of a helical rod 32 supported by the wrist 24′ of the robot arm 24. A rod-driven motor—not shown—is housed in the wrist 24′ that actuatable to cause a roto-translation of the helical rod. In other words, a rotation of the helical rod 32 corresponds to a translation thereof in the vertical direction and consequently to a movement in the vertical direction of the motor group 30 and thus of the drill or die-cutting bit 22 connected thereto.

FIGS. 2b and 3 show an example of a tool group 40 comprising a drill or die-cutting bit 22. The die-cutting bit differs from the drill bit in that it consists of a hollow tubular body ending in a sharp edge.

The drill and die-cutting bits 22 end at the top with a ring gear 222 suitable for rotationally coupling with a corresponding ring gear of the rotor of the motor group 30.

Each drill or die-cutting bit 22 is rotatably supported by a tool holder plate 42.

This tool holder plate 42 is provided with an axial relief 44, for example conical in shape, facing the motor group 30 and housing ball bearings 46 (or equivalent means of rotatable support) for the rotation of the drill or die-cutting bit 22. The upper portion of the drill or die-cutting bit, bearing the ring gear 222, protrudes above this axial relief 44.

In one embodiment, the axial relief 44 is suitable to couple geometrically with the lower part of the body of the motor group 30. Further, in one embodiment, the axial relief 44, or a portion thereof, forms a motor group 30 attachment element.

For example, in one embodiment, the coupling means to the tool group comprise one or more blocking pins or balls or other radial blocking means supported by the motor group 30 and suitable for engaging corresponding recesses obtained in a collar 44′ which extends from the top of the axial relief 44. Once the motor group 30 is in contact with the axial relief 44 of the tool holder plate 42, a rotation of the helical rod 32, and thus of the body of the motor group 30, causes the axial blocking between the motor group 30 and the axial relief 44. For example, this rotation of the helical rod 32 is 45°. As a result of this rotation, as a matter of fact, the aforementioned radial blocking means engage the corresponding recesses of the collar 44′.

In a variant embodiment, the body of the motor group 30 comprises or supports pneumatically operable tool group coupling means, for example in the form of a gripper, suitable for providing the coupling between the motor group 30 and the tool group 40.

At the bottom, the drill or die-cutting bit 22 is guided slidingly into a lower piece support plate 48. This lower plate 48 is elastically connected to the tool holder plate 42, for example by means of a pair of elastic elements 50, such as helical springs wound on respective side guide columns 52. The lower plate 48 is suitable for resting on the flat piece, holding it in place, when the drill or die-cutting bit 22 descends to drill through the flat piece.

In one embodiment, the tool holder plate 42 forms an anchor extension 42′ suitable for being coupled to a support bracket 54 for the tool group 40.

In one embodiment, the support bracket 54 for the tool group 40 is mounted on the arm beam 28 that supports the robot arm 24.

Therefore, the arm beam 28 also serves as a tool holder magazine to support tool groups 40 with drill or die-cutting bits 22 of different diameters.

In one embodiment illustrated particularly in FIG. 2b, the robotic arm 24 comprises an ejector rod 60 translatable in the die-cutting bit 22 to eject the cut material in the die-cutting bit 22.

In one embodiment, the ejector rod 60 is connected to a piston rod 62 of a pneumatic cylinder 64 mounted on top of the helical rod 32. In this embodiment, the helical rod 32 is hollow and slidingly houses the piston rod 62.

In other embodiments, the ejector-motor-drilling tool group does not work coaxially with the helical rod of the robot, but may be fixed thereto with side brackets and thus work in an “offset” manner. The cutting machine 1 equipped with the drilling and/or die-cutting unit 20 according to the invention operates as follows.

The flat piece is advanced from the loading area to the unloading area, for example by actuating the cutting mat 12 if it is of a conveyor belt type.

When the flat piece is exclusively within the first (A1) or second (A2) area of the cutting mat, the cutting unit 24 or the drilling and/or die-cutting unit 20 is actuated, respectively.

On the other hand, when the flat piece is at least partially within both the first and second areas (A1, A2) of the cutting mat, the electronic control unit 300 simultaneously actuates both the cutting unit 14 and the drilling and/or die-cutting unit 20.

In one embodiment, the cutting path is described in a CAD file that also includes the drilling and/or die-cutting path.

In this case, the electronic control unit of the cutting machine acquires the CAD file and then transmits the coordinates of the cutting path to the electric actuators of the cutting unit 14 and the coordinates of the drilling and/or die-cutting path to the electric actuators of the drilling and/or die-cutting unit 20.

The drilling and/or die-cutting unit 20 operates in the following way.

The robotic arm 24 is commanded to proceed with the coupling of a tool group 40.

In particular, the helical rod 32 is positioned with the motor group 30 above the tool group 40; the helical rod 32 is commanded to descend to a position defined by the coupling between the axial relief 44 of the tool holder plate and the body of the motor group 30. At this point the coupling means to the tool group 40 are actuated. For example, the helical rod 32 is rotated, for example by an angle of 45°, to provide the coupling between the motor group 30 and the tool group 40. In other embodiments, as mentioned above, pneumatic coupling means, such as in the form of a gripper, are actuated to clamp and block the tool group 40.

Once the tool group 40 is coupled, the robot arm 24 is commanded to bring the tool group 40 to the position where a hole is to be drilled in the flat piece.

The method for making a hole by die-cutting is as follows.

The rotation of the motor group 30 is started, which also puts the die-cutting bit 22 into rotation accordingly; the helical rod 32 descends, causing the cutting edge of the die-cutting bit 22 to penetrate the material of the flat piece, for example by bringing it about one centimeter beyond the thickness of the material being processed. After a predetermined time interval, such as half a second, the helical rod 32 is returned to the inactive raised position. During this step of lifting the helical rod 32, the ejector cylinder 64 positioned above the helical rod 32 is actuated. The cylinder 64 actuates the relative piston 62 and then the ejector rod 60 connected thereto, causing the cut material to be discharged from the die.

Drilling a hole by means of a drill bit is done in the same way, with the only difference (besides the higher RPM of the torque motor) being that the ejector rod 60 remains in an idle raised position since there is no cut material inside the drill bit.

The machining cycle involves drilling all holes in sequence where the same die or drill bit is required, otherwise a tool change is performed.

If a tool change is required, the robotic arm 24 is commanded to position itself over an empty tool group 40 support bracket 54. The helical rod 32 descends until the coupling extension 42′ of the tool holder plate 40 engages the support bracket 54. At this point, the motor group 30 may be disengaged from the tool group 40, for example through a 45° rotation of the helical rod 32 or by deactivating the pneumatic coupling means.

The helical rod 32 is then lifted and repositioned on top of a tool group 40 to be coupled. The coupling of the new tool group 40 is done according to the method described above.

It should be noted that, in place of a drill or die-cutting bit 22, the drilling and/or die-cutting unit 20 could use a die or blade suitable for making shaped cuts, such as V-shaped, in place of holes. However, the structure and operation of the drilling and/or die-cutting unit remain essentially the same, except for obvious adaptations that the person skilled in the art may make as needed.

A person skilled in the art may make several changes, adjustments, adaptations and replacements of elements with others that are functionally equivalent to the embodiments of the drilling and/or die-cutting unit according to the invention in order to meet incidental needs, without departing from the scope of the following claims. Each of the features described as belonging to a possible embodiment may be obtained independently of the other described embodiments.

What is claimed is:

1. A drilling and/or die cutting unit, comprising a robotic arm on whose wrist an electromechanical member suitable for operatively supporting a drill or die cutting bit is mounted, wherein said electromechanical member comprises a toroidal-shaped motor group extending about a motor rotation axis and provided with coupling means for coupling to the drill or die cutting bit, said coupling means being suitable for supporting the drill or die cutting bit coaxially to said motor rotation axis.

2. The drilling and/or die cutting unit of claim 1, wherein the robotic arm is suitable for making movements only in a plane parallel to [the] a flat piece to be drilled, optionally the plane parallel to the flat piece to be drilled being a horizontal plane, and wherein the electromechanical member is suitable for moving the drill or die cutting bit in a direction orthogonal to the flat piece to be drilled, optionally the direction orthogonal to the flat piece to be drilled being a vertical direction.

3. The drilling and/or die cutting unit of claim 1, wherein the motor group is fixed to a lower end of a helical rod supported by the wrist of the robotic arm, and wherein in said wrist a rod actuation motor is housed, said rod actuation motor being operable to induce a roto-translation of the helical rod.

4. The drilling and/or die cutting unit of claim 1, wherein the drill or die cutting bit ends at a top thereof with a ring gear suitable for rotationally coupling with a corresponding ring gear of a rotor of the motor group.

5. The drilling and/or die cutting unit of claim 1, wherein the drill or die cutting bit is rotatably supported by a tool holder plate from which an axial relief extends, and wherein the axial relief houses rotatable support means of the drill or die cutting bit and is suitable for geometrically coupling with a lower part of a body of the motor group.

6. The drilling and/or die cutting unit of claim 5, wherein the motor group is fixed to a lower end of a helical rod supported by the wrist of the robotic arm, wherein in said wrist a rod actuation motor is housed, said rod actuation motor being operable to induce a roto-translation of the helical rod, and wherein tool group coupling means comprise one or more blocking pins or balls or other radial blocking means supported by the motor group and suitable for engaging corresponding recesses in a collar which extends from a top of the axial relief, a rotation of the helical rod, and therefore of the body of the motor group, being suitable for causing axial blocking between the motor group and the axial relief.

7. The drilling and/or die cutting unit of claim 5, wherein the body of the motor group comprises or supports pneumatically operable tool group coupling means, optionally the pneumatically operable tool group coupling means being a gripper, suitable for providing coupling between the motor group and the axial relief.

8. The drilling and/or die cutting unit of claim 5, wherein the drill or die cutting bit is slidingly guided in a lower piece support plate elastically connected to the tool holder plate.

9. The drilling and/or die cutting unit of claim 5, wherein the robotic arm is mounted on a support structure, and wherein the tool holder plate forms an anchor extension suitable for being coupled to a support bracket fixed to said support structure.

10. The drilling and/or die cutting unit of claim 1, wherein the robotic arm comprises an ejector rod translatable inside the die cutting bit to eject cut material in the die cutting bit.

11. The drilling and/or die cutting unit of claim 3, wherein the robotic arm comprises an ejector rod translatable inside the die cutting bit to eject cut material in the die cutting bit, and wherein the helical rod is hollow and slidingly accommodates the ejector rod, the ejection rod being actuated by an actuator, optionally the actuator being a pneumatic actuator, mounted on a top of the helical rod.

12. The drilling and/or die cutting unit of claim 1, wherein the drilling and/or die cutting unit is for flat pieces made of deformable materials, optionally the flat pieces made of deformable materials being textiles.
